(19) United States
(12) Patent Application Publication
(10) Pub. No.: US 2015/0254756 A1
(43) Pub. Date: Sep. 10, 2015

(54) SIMPLE ORDER SYSTEM AND METHOD

(71) Applicant: SK PLANET CO., LTD., GYEONGGI-DO (KR)

(72) Inventors: JAE HYUNG HUH, GYEONGGI-DO (KR); CHUL YONG SHIN, SEOUL (KR)

(73) Assignee: SK PLANET CO., LTD., GYEONGGI-DO (KR)

(21) Appl. No.: 14/536,154

(22) Filed: Nov. 7, 2014

(30) Foreign Application Priority Data
Mar. 7, 2014 (KR) 10-2014-0027140

(51) Int. Cl. G06Q 30/06; G06Q 20/32; G06Q 20/12

(52) U.S. Cl. CPC G06Q 30/0633; G06Q 20/12; G06Q 20/322

(57) ABSTRACT

A mobile terminal is disclosed. The mobile terminal includes: a wireless signal detector configured to detect a wireless signal transmitted from the outside; an application driver configured to execute an application corresponding to the detected wireless signal and receive order information of a product selected by a user through the application and payment information related to the order information; and a transceiver configured to transmit the order information and the payment information and receive a response to the transmitted order information and payment information.

### BACKGROUND OF THE INVENTION

1. Field of the invention

The present disclosure relates to an apparatus and a method for ordering and paying for a product by using a mobile terminal. More particularly, the present disclosure relates to a system capable of ordering and paying for a product/service through a mobile terminal immediately when a user of the mobile terminal enters a particular shop, and an operation method thereof.

2. Description of the Prior Art

Recently, according to the supply of mobile terminals, a plurality of purchase and payment services using the mobile terminal have been introduced. Particularly, improving the user convenience through an interworking with a shop sale system (for example, a Point Of Sales (POS) system) is a main interest.

The POS system is a sale management system which intensively manages sale information by recording information on sold products immediately when the products are sold. The POS system is a synthetic sale management system for enhancing a future customer response capability by connecting an order processing system of the shop with a manager server online to combine, analyze, and evaluate information at a sale time point.

In general, the POS system is driven by attaching a barcode or an OCR tag (a price tag for an optical character recognition device) to a product and reading the barcode or tag through a scanner, so as to automatically calculate a price and collect and input all pieces of information on the product at the same time.

However, since most sale systems are operated from a payment step after a customer makes a purchase decision, the sale systems cannot provide the convenience up to an order time point after the customer enters a shop in many cases. In a shop such as a coffee shop, a restaurant or the like in which a customer should directly take a product after ordering the product, the customer should wait in line in front of a counter to order and make payment and take a number ticket or a notification bell to pick up the prepared product, which makes the customer feel inconvenience.

Accordingly, a more improved sale management system is required to remove the above customer inconvenience.

### SUMMARY OF THE INVENTION

An aspect of the present disclosure is to provide an apparatus and a method for ordering and paying for a product by using a mobile terminal. More specifically, the present disclosure provides a system in which, a customer enters a particular shop, the customer can order and pay for a product/service through a mobile terminal, and an operation method thereof.

In accordance with an aspect of the present disclosure, a mobile terminal is provided. The mobile terminal includes: a wireless signal detector configured to detect a wireless signal transmitted from the outside; an application driver configured to execute an application corresponding to the detected wireless signal and receive order information of a product selected by a user through the application and payment information related to the order information; and a transceiver configured to transmit the order information and the payment information and receive a response to the transmitted order information and payment information.

The transceiver may further receive call information informing that a product corresponding to the order information and the payment information is prepared.

The wireless signal may be a Bluetooth signal.

The wireless signal detector may extract an identifier of a shop corresponding to the wireless signal and transmit the extracted identifier of the shop to the application driver.

The application driver may access a predetermined service server to acquire shop information corresponding to the identifier of the shop, and the shop information may include at least one of product information, price information, and event information.

In accordance with another aspect of the present disclosure, a method of ordering and paying for a product by a mobile terminal is provided. The method includes: detecting a wireless signal transmitted from the outside; executing an application corresponding to the detected wireless signal; receiving order information of a product selected by a user through the application and payment information related to the order information; and transmitting the order information and the payment information and receiving a response to the transmitted order information and payment information.

The method may further include receiving call information informing that a product corresponding to the order information and the payment information is prepared.

The wireless signal may be a Bluetooth signal.

The detecting of the wireless signal may include extracting an identifier of a shop corresponding to the wireless signal.

The method may further include accessing a predetermined service server to acquire shop information corresponding to the identifier of the shop, wherein the shop information may include at least one of product information, price information, and event information.

In accordance with another aspect of the present disclosure, a method of ordering a product using a mobile terminal is provided. The method includes: transmitting a wireless signal corresponding to a particular shop by a wireless signal transmitter; detecting the wireless signal transmitted from the wireless signal transmitter by a mobile terminal; executing an application corresponding to the detected wireless signal by the mobile terminal; transmitting order information of a product selected by a user through the application and payment information related to the order information to a service server by the mobile terminal; transmitting the order information and payment information received from the mobile terminal to a shop terminal by the service server; and receiving the order information and the payment information from the service server and displaying the received order information and payment information by the shop terminal.

Embodiments of the present disclosure can provide effects of minimizing a waiting time of a customer when the customer orders a product in a shop and allowing the customer to easily recognize the preparation of the ordered product. Further, embodiments of the present disclosure can provide not only a more pleasant and convenient shopping experience to shop visitors but also bigger convenience in managing the shop to a shop manager.

### BRIEF DESCRIPTION OF THE DRAWINGS

The above and other objects, features and advantages of the present disclosure will be more apparent from the following detailed description taken in conjunction with the accompanying drawings, in which:

FIG. 1 illustrates a concept for describing an order system according to an embodiment of the present disclosure;

FIGS. 2A to 2C illustrate an example of a process of ordering and paying for a product according to an embodiment of the present disclosure;

FIG. 3 is a block diagram illustrating a mobile terminal according to an embodiment of the present disclosure; and

FIG. 4 is a flowchart illustrating a method of ordering and paying for a product according to an embodiment of the present disclosure.

### DETAILED DESCRIPTION OF THE EXEMPLARY EMBODIMENTS

It should be noted that the technical terms in the specification are merely used for describing a specific embodiment but do not limit the scope of the present invention. Further, the technical terms in the specification should be construed as a meaning generally understood by those skilled in the art unless the terms are defined as another meaning and should not be construed as an excessively inclusive meaning or an excessively exclusive meaning. When a technical term used in the specification is a wrong technical term which does not accurately express the idea of the present disclosure, the technical term should be replaced with a correct technical term which can be understood by those skilled in the art. Further, the general terms used in the present disclosure should be interpreted in the context according to the definition in the dictionary and should not be construed as an excessively limited meaning.

Hereinafter, exemplary embodiments of the present disclosure will be described in detail with reference to the accompanying drawings, equal or similar elements are assigned an equal reference numeral, and an overlapping description thereof will be omitted. Further, in the following description of the present invention, a detailed description of known technologies incorporated herein will be omitted when it may make the subject matter of the present disclosure rather unclear. Further, it should be noted that the accompanying drawings are intended only for the easy understanding of the technical idea of the present invention, and the spirit of the present invention should not be construed as being limited by the accompanying drawings. In addition to the accompanying drawings, the spirit of the present invention should be construed to cover all modifications, equivalents, and alternatives thereof.

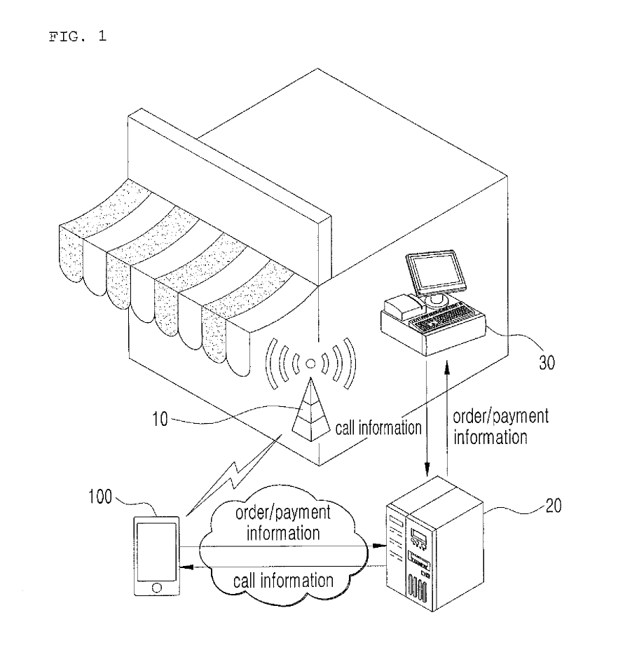

FIG. 1 illustrates a concept for describing an order system according to an embodiment of the present disclosure.

The order system may include a wireless signal transmitter 10, a service server 20, and a shop terminal 30. A mobile terminal 100 may use a simple order and/or payment service through an interworking with the order system.

The mobile terminal 100 may transmit/receive a voice, data, various pieces of information and the like through a wired/wireless communication network. At this time, the mobile terminal 100 may include a display which may display data, information and the like received through the communication network. Meanwhile, the mobile terminal 100 may have various application programs, particularly, an application for the simple order/payment service provided by the present disclosure.

The wireless signal transmitter 10 transmits a wireless signal indicating a particular shop. At this time, the wireless signal transmitter 10 may be a Bluetooth beacon, a Bluetooth Low Energy (BLE) beacon, or a Wi-Fi Access Point (AP). In each case, the wireless signal may be a Bluetooth signal or a Wi-Fi signal. The wireless signal may include an identifier (ID) for identifying a particular shop.

The service server 20 may provide the simple order and/or payment service. Particularly, through an interworking with the wireless signal transmitter 10 and the shop terminal 30, the service server 20 may enable a user who enters a particular shop to easily receive an order/payment/call service by using a mobile terminal belonging to the user without directly ordering at a counter. That is, the service server 20 may receive and process order/payment information of a product of the corresponding shop from the mobile terminal having detected a wireless signal when the customer is located near the shop or enters the shop, transmit the order/payment information to the shop terminal (for example, a POS terminal), receive call information informing that the ordered product is prepared from the shop terminal 30, and transmit the call information to the corresponding mobile terminal 100. At this time, the service server 20 may be configured to transmit/receive information to/from the mobile terminal 100 through an interworking with a communication network. The communication network is a wired or wireless communication network including an exchanger and provides a communication service to the mobile terminal 100.

The shop terminal 30 may include an interface which may perform sale and payment processing of a particular shop, receive order/payment information from the service server 20, display the received order/payment information, and inform the service server 20 that the ordered product is prepared. Further, the shop terminal 30 may interwork with the service server 20 while being located in a separated position from the service server 20 or may have a function of the service server 20 to directly communicate with the mobile terminal 100. As described above, when the function of the service server 20 is included within the shop terminal 30, the shop terminal 30 and the mobile terminal 100 may communicate with each other by using a short range communication network instead of a mobile communication network.

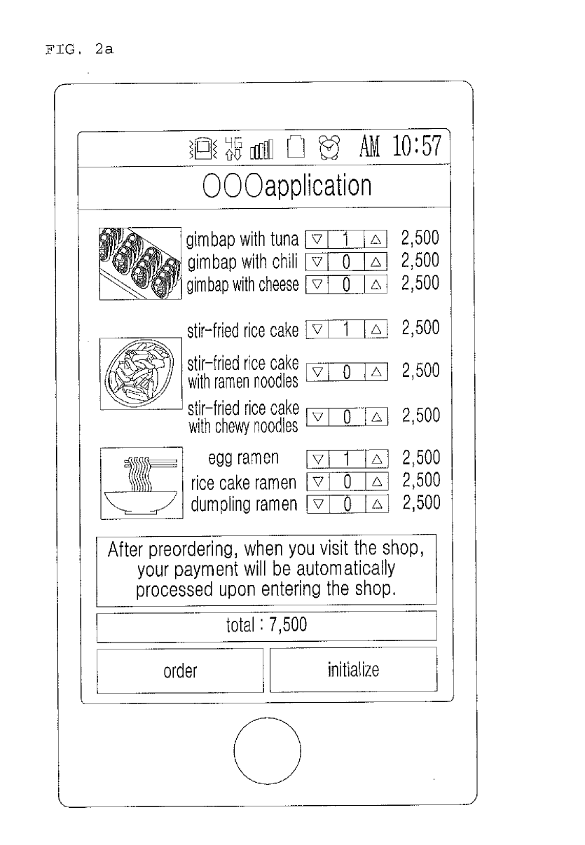

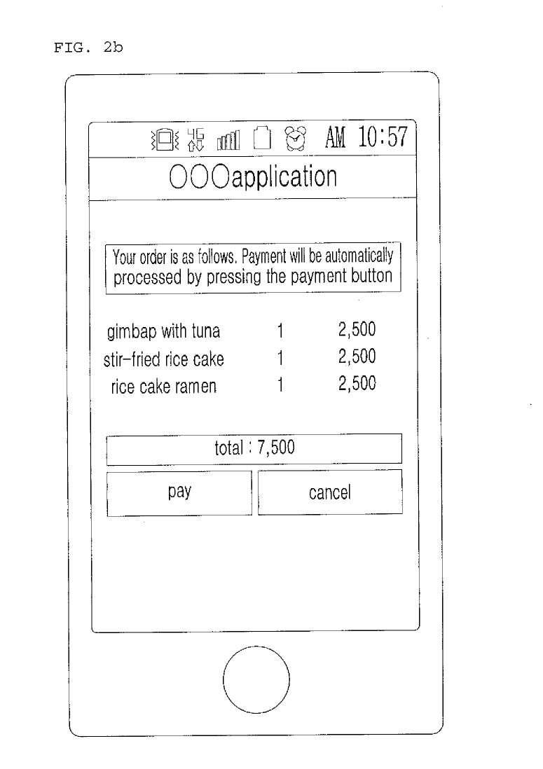

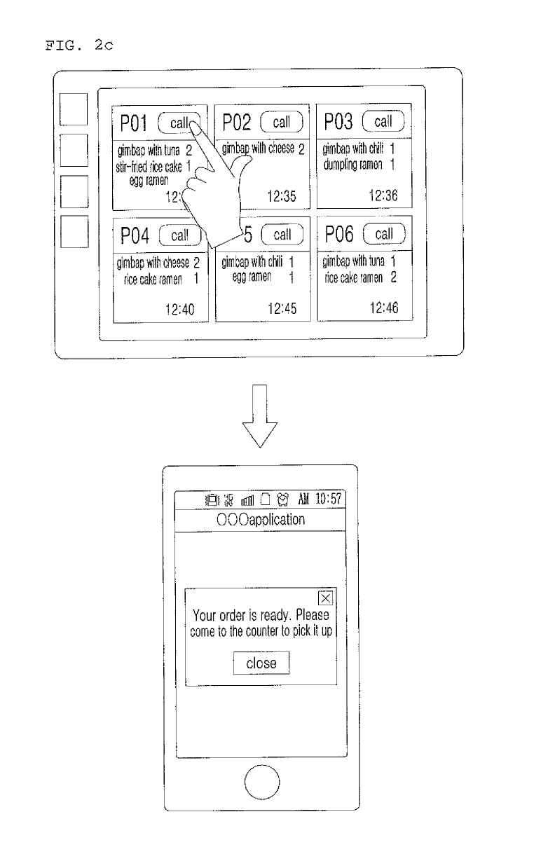

Hereinafter, the operation of the order system will be described in detail with reference to FIGS. 1 and 2A to 2C.

When a user carrying the mobile terminal 100 approaches a particular shop or enters the shop, the mobile terminal 100 detects a wireless signal broadcasted from the wireless signal transmitter 10. The wireless signal is defined to distinguish between several shops and the distinguishment may be achieved by a frequency or timing or may be performed by including a shop identifier in the wireless signal. The distinguishment between shops using the wireless signal may be designated and operated based on each franchise company.

The mobile terminal 100 having detected the wireless signal executes an application (App) corresponding to the detected wireless signal. The application may be an application configured to recognize a shop mapped according to the wireless signal and to display product, price, and event information of the recognized shop. It is preferable that the application is configured by one program available in all shops rather than separated programs of respective shops.

Meanwhile, the application may have information on all shops by itself or may be configured to access the service server 20 to acquire shop information (product information, price information, event information and the like) of the detected shop when being executed, in order to provide changes in products or prices or the event information available only for a predetermined period or only in a particular shop (real time update). Further, the shop information may further include empty seats in the corresponding shop, a product review/evaluation score of a sold product, and neighboring shop information.

The mobile terminal 100 may enable the user to select a product of the corresponding shop through the executed application. As illustrated in an example of FIG. 2A, the mobile terminal 100 displays items sold in the corresponding shop and price information to allow the user to select a desired product from the displayed items. At this time, in addition to the items and the price information, a product review or an evaluation score of each product may be further displayed.

Further, the mobile terminal 100 may display information for the payment immediately when the selection of the item by the user is completed as illustrated in an example of FIG. 2B.

As described above, the mobile terminal 100 receives order information (the item, a quantity and the like) of the product selected by user through the application and payment information (the price, a means for payment and the like) related to the order information and transmits the order information and the payment information to the service server 20.

The service server 20 having received the order information and the payment information accepts the order and performs payment processing, and then transmits the order information and the payment information to the shop terminal 30. Further, the service server 20 transmits a result of the order and payment processing to the mobile terminal 100.

The shop terminal 30 having received the order information and the payment information from the service server 20 displays the received order information and payment information and enables an employee to view the displayed order information and to prepare the corresponding item.

When the product corresponding to the order information and the payment information is prepared, the shop terminal 30 transmits call information to notify the preparation of the product. That is, when a shop employee selects the prepared product in the display screen as illustrated in an upper side of FIG. 2C, the shop terminal 30 transmits call information to inform the service server 20 that the product corresponding to the order information and the payment information is prepared.

The service server 20 having received the call information transmits the call information to the mobile terminal 100 through a Short Message Service (SMS), a MultiMedia Service (MMS), a push message or the like. An example of the call information is illustrated in a lower side of FIG. 2C. A user (shop customer) carrying the mobile terminal 100 identifies the call information and receives the ordered product.

Through the above described embodiment of the present disclosure, the user visiting the shop does not need to wait in front of a counter to order or pay for a product and an employee can easily inform that the ordered product is prepared.

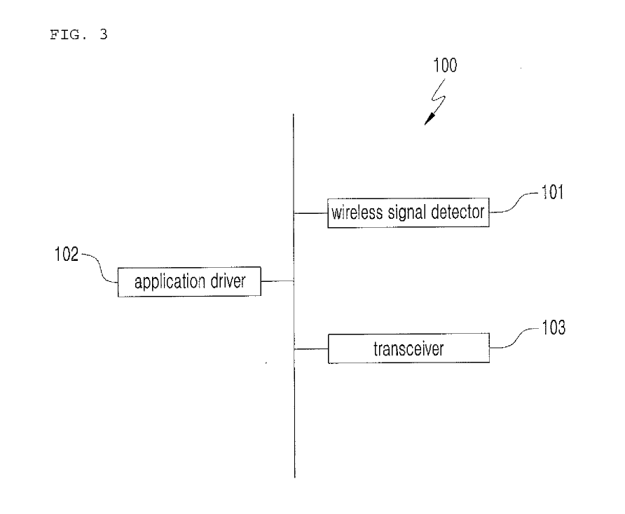

FIG. 3 is a block diagram illustrating the mobile terminal according to an embodiment of the present disclosure.

The mobile terminal 100 may transmit/receive a voice, data, various pieces of information and the like through a wired/wireless communication network. At this time, the mobile terminal 100 may include a display which may display data, information and the like received through the communication network. Meanwhile, the mobile terminal 100 may have various application programs, particularly, an application for the simple order/payment service provided by the present disclosure.

The mobile terminal 100 may include a wireless signal detector 101, an application driver 102, and a transceiver 103. The mobile terminal 100 may further include a display unit, a storage unit and the like.

The wireless signal detector 101 may detect a wireless signal transmitted from the outside. At this time, the wireless signal may be a Bluetooth signal or a Wi-Fi signal. The wireless signal may include an identifier (ID) for identifying a particular shop. At this time, the wireless signal detector 101 may extract an identifier of a shop corresponding to the wireless signal and transmit the extracted identifier of the shop to the application driver 102.

The application driver 102 may execute an application corresponding to the detected wireless signal. The application may be an application configured to recognize a shop mapped according to the wireless signal and to display product, price, and event information of the recognized shop. It is preferable that the application is configured by one program available in all shops rather than separated programs of respective shops. Meanwhile, the application may have information on all shops by itself or may be configured to access a predetermined service server to acquire shop information (product information, price information, event information and the like) of the detected shop when being executed, in order to provide changes in products or prices or the event information available only for a predetermined period or only in a particular shop (real time update). Further, the shop information may further include empty seats in the corresponding shop, a product review/evaluation score of a sold product, and neighboring shop information.

The application driver 102 receives order information of a product selected by the user through the application and payment information related to the order information. As illustrated in the example of FIG. 2A, the application driver 102 displays items sold in the corresponding shop and price information to allow the user to select a desired product from the displayed items. At this time, in addition to the items and the price information, a product review or an evaluation score of each product may be further displayed.

Further, the application driver 102 may display information for the payment immediately when the selection of the item by the user is completed as illustrated in the example of FIG. 2B.

As described above, when the order information (the item, the quantity and the like) of the product selected by the user and the payment information (the price, the means for payment and the like) related to the order information are input through the application driver 102, the transceiver 103 may transmit the order information and the payment information and receive a response to the transmitted order information and payment information.

The service server having received the order information and the payment information accepts the order and performs payment processing, and then transmits the order information and the payment information to the shop terminal. Further, the service server transmits a result of the order and payment processing to the mobile terminal.

The shop terminal having received the order information and the payment information from the service server displays the received order information and payment information and enables an employee to view the displayed order information and to prepare the corresponding item.

When the product corresponding to the order information and the payment information is prepared, the shop terminal transmits call information to notify of the preparation of the product. That is, when a shop employee selects the prepared product in the display screen as illustrated in an upper side of FIG. 2C, the shop terminal transmits call information to inform the service server that the product corresponding to the order information and the payment information is prepared.

The service server having received the call information transmits the call information to the mobile terminal 100 through a SMS, an MMS, a push message or the like. An example of the call information is illustrated in a lower side of FIG. 2C. 9A user (shop customer) carrying the mobile terminal 103 identifies the call information and receives the ordered product.

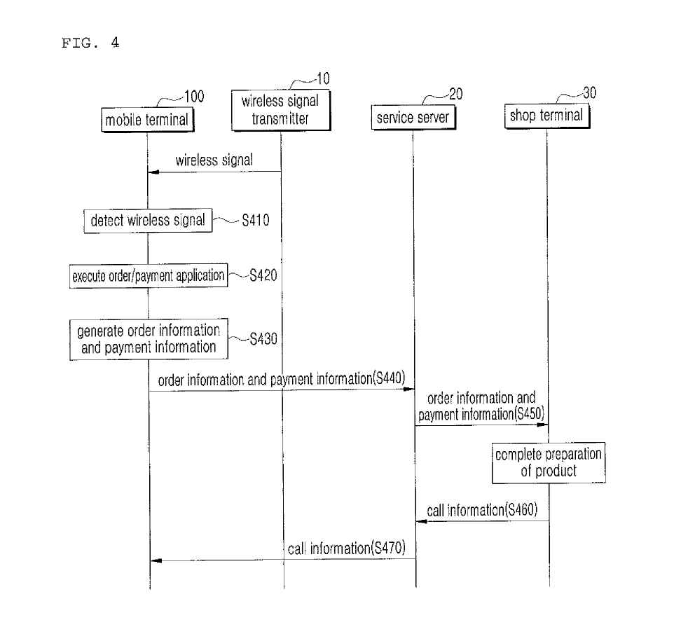

FIG. 4 is a flowchart illustrating a method of ordering and paying for a product according to an embodiment of the present disclosure.

A method described below may be performed by the mobile terminal 100 and the order system described in FIGS. 1 to 3. The order system may include the wireless signal transmitter 10, the service server 20, and the shop terminal 30. The mobile terminal 100 may use a simple order and/or payment service through an interworking with the order system.

The mobile terminal 100 may transmit/receive a voice, data, various pieces of information and the like through a wired/wireless communication network. At this time, the mobile terminal 100 may include a display which may display data, information and the like received through the communication network. Meanwhile, the mobile terminal 100 may have various application programs, particularly, an application for the simple order/payment service provided by the present disclosure.

The wireless signal transmitter 10 transmits a wireless signal indicating a particular shop. At this time, the wireless signal transmitter 10 may be a Bluetooth beacon or a Wi-Fi Access Point (AP). In each case, the wireless signal may be a Bluetooth signal or a Wi-Fi signal. The wireless signal may include an identifier (ID) for identifying a particular shop.

The service server 20 may provide the simple order and/or payment service. Particularly, through an interworking with the wireless signal transmitter 10 and the shop terminal 30, the service server 20 may enable a user who enters a particular shop to easily receive an order/payment/call service by using a mobile terminal belonging to the customer without directly ordering at a counter. That is, the service server 20 may receive and process order/payment information of a product of the corresponding shop from the mobile terminal having detected a wireless signal when the customer is located near the shop or enters the shop, transmit the order/payment information to the shop terminal (for example, a POS terminal), receive call information informing that the ordered product is prepared from the shop terminal 30, and transmit the call information to the corresponding mobile terminal 100. At this time, the service server 20 may be configured to transmit/receive information to/from the mobile terminal 100 through an interworking with a communication network. The communication network is a wired or wireless communication network including an exchanger and provides a communication service to the mobile terminal 100.

The shop terminal 30 may include an interface which may perform sale and payment processing of a is particular shop, receive order/payment information from the service server 20, display the received order/payment information, and inform the service server 20 that the ordered product is prepared. Further, the shop terminal 30 may interwork with the service server 20 while being located in a separated position from the service server 20 or may have a function of the service server 20 to directly communicate with the mobile terminal 100. As described above, when the function of the service server 20 is included within the shop terminal 30, the shop terminal 30 and the mobile terminal 100 may communicate with each other by using a short range communication network instead of a mobile communication network.

When a user carrying the mobile terminal 100 approaches a particular shop or enters the shop, the mobile terminal 100 detects a wireless signal broadcasted by the wireless signal transmitter 10 in step S410. The wireless signal is defined to distinguish between several shops and the distinguishment may be achieved by a frequency or timing or may be performed by including a shop identifier in the wireless signal. The distinguishment between shops using the wireless signal may be designated and operated based on each franchise company.

The mobile terminal 100 having detected the wireless signal executes an application (App) corresponding to the detected wireless signal in step S420. The application may be an application configured to recognize a shop mapped according to the wireless signal and to display product, price, and event information of the recognized shop. It is preferable that the application is configured by one program available in all shops rather than separated programs of respective shops.

Meanwhile, the application may have information on all shops by itself or may be configured to access the service server 20 to acquire shop information (product information, price information, event information and the like) of the detected shop when being executed, in order to provide changes in products or prices or the event information available only for a predetermined period or only in a particular shop (real time update). Further, the shop information may further include empty seats in the corresponding shop, a product review/evaluation score of a sold product, and neighboring shop information.

The mobile terminal 100 may enable the user to select a product of the corresponding shop through the executed application. As illustrated in an example of FIG. 2A, the mobile terminal 100 displays items sold in the corresponding shop and price information to allow the user to select a desired product from the displayed items. At this time, in addition to the items and the price information, a product review or an evaluation score of each product may be further displayed.

Further, the mobile terminal 100 may display information for the payment immediately when the selection of the item by the user is completed as illustrated in an example of FIG. 2B.

As described above, the mobile terminal 100 receives order information (the item, a quantity and the like) of the product selected by user through the application and payment information (the price, a means for payment and the like) related to the order information and transmits the order information and the payment information to the service server 20 in step S440.

The service server 20 having received the order information and the payment information accepts the order and performs payment processing, and then transmits the order information and the payment information to the shop terminal 30 in step S450. Further, the service server 20 transmits a result of the order and payment processing to the mobile terminal 100.

The shop terminal 30 having received the order information and the payment information from the service server 20 displays the received order information and payment information and enables an employee to view the display order information and to prepare the corresponding item.

When the product corresponding to the order information and the payment information is prepared, the shop terminal 30 transmits call information to notify of the preparation of the product in step S460. That is, when a shop employee selects the prepared product in the display screen as illustrated in an upper side of FIG. 2C, the shop terminal 30 transmits call information to inform the service server 20 that the product corresponding to the order information and the payment information is prepared in step S470.

The service server 20 having received the call information transmits the call information to the mobile terminal 100 through an SMS, an MMS, a push message or the like. An example of the call information is illustrated in a lower side of FIG. 2C. A user (shop customer) carrying the mobile terminal 100 identifies the call information and receives the ordered product.

As described above, those skilled in the art can appreciate that it is possible to implement the present disclosure in other detailed forms without changing the technical idea or the indispensable characteristics of the present disclosure. It will be understood that the above-described aspects are illustrative and are not limiting under any possible interpretation.

For example, the mobile terminal according to the present disclosure may store information by a memory. In an implementation example, the memory is a computer-readable medium. In an implementation example, the memory may be a volatile memory unit. In another implementation example, the memory may be a non-volatile memory unit. Further, the memory may include, for example, a hard disk device, an optical disk device, or other large capacity storage devices.

The mobile terminal 100 or the service server 20 may be implemented by a command for allowing one or more processing units to perform the above described function and process. For example, the command may include an interpreted command such as a script command, for example, a JavaScript or ECMAScript command, an executable code, or other commands stored in a computer-readable medium.

The implementations of the functional operations and subject matter described in the present disclosure may be realized by a digital electronic circuit, by the structure described in the present disclosure and the equivalent including computer software, firmware, or hardware including, or by a combination of one or more thereof. Implementations of the subject matter described in the specification may be implemented in one or more computer program products, that is, one or more modules related to a computer program command encoded on a tangible program storage medium to control an operation of a processing system or the execution by the operation.

A computer-readable medium may be a machine-readable storage device, a machine-readable storage substrate, a memory device, a composition of materials influencing a machine-readable radio wave signal, or a combination of one or more thereof.

In the specification, the term “system” or “device”, for example, covers a programmable processor, a computer, or all kinds of mechanisms, devices, and machines for data processing, including a multiprocessor and a computer. The processing system may include, in addition to hardware, a code that creates an execution environment for a computer program when requested, such as a code that constitutes processor firmware, a protocol stack, a database management system, an operating system, or a combination of one or more thereof.

A computer program (also known as a program, software, software application, script, or code) can be written in any form of programming language, including compiled or interpreted languages, declarative or procedural languages, and it can be deployed in any form, including as a stand-alone program or module, a component, subroutine, or another unit suitable for use in a computer environment. A computer program may, but need not, correspond to a file in a file system. A program can be stored in a single file provided to the requested program, in multiple coordinated files (for example, files that store one or more modules, sub-programs, or portions of code), or in a portion of a file that holds other programs or data (for example, one or more scripts stored in a markup language document). A computer program can be deployed to be executed on one computer or on multiple computers that are located at one site or distributed across a plurality of sites and interconnected by a communication network.

A computer-readable medium suitable for storing a computer program command and data includes all types of non-volatile memories, media, and memory devices, for example, a semiconductor memory device such as an EPROM, an EEPROM, and a flash memory device, and a magnetic disk such as an external hard disk or an external disk, a magneto-optical disk, a CD-ROM, and a DVD-ROM disk. A processor and a memory may be added by a special purpose logic circuit or integrated into the logic circuit.

While the specification contains many specific implementation details, these should not be construed as limitations on the scope of any disclosure or of what may be claimed, but rather as descriptions of features that may be specific to particular embodiments of particular disclosures. Certain features that are described in the specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Further, although the operations are illustrated according to particular orders in the present disclosure, it is not to be understood that the operations should be sequentially performed according to such orders or that all the operations illustrated should be performed, in order to acquire an exemplary result. In a particular case, multi-tasking and parallel processing may be advantageous. Further, it should not be understood that the separation of various system components in the above embodiments is required in all embodiments, and it should be noted that the program component and systems may be generally integrated into a single software product or may be packaged into multiple software products.

As described above, the present specification does not limit the present disclosure to the provided detailed terms. Accordingly, although the present disclosure has been described in detail with reference to the examples, some remodeling, modifications, and changes can be made in the embodiments by those skilled in the art without departing from the scope of the present disclosure. The scope of the present disclosure is defined by the appended claims to be described later, rather than the detailed description. Accordingly, it will be appreciated that all modifications or variations derived from the meaning and scope of the appended claims and their equivalents are included in the range of the present disclosure.

### INDUSTRIAL APPLICABILITY

An order system according to an embodiment of the present disclosure and an operation method thereof are highly applicable to the industries since related technologies of the present disclosure can be used and also the device to which the present disclosure is applied has a high probability of entering into the market and being sold, and thus the present disclosure can be obviously implemented in reality in that a mobile terminal executes an application corresponding to a detected wireless signal and transmits order information on a product selected by a user through the application and payment information related to the order information, thereby providing a more pleasant and convenient shopping experience to shop costumers.

What is claimed is:

1. A mobile terminal comprising:
a wireless signal detector configured to detect a wireless signal transmitted from the outside;
an application driver configured to execute an application corresponding to the detected wireless signal and receive order information of a product selected by a user through the application and payment information related to the order information; and
a transceiver configured to transmit the order information and the payment information and receive a response to the transmitted order information and payment information.

2. The mobile terminal of claim 1, wherein the transceiver further receives call information informing that a product corresponding to the order information and the payment information is prepared.

3. The mobile terminal of claim 1, wherein the wireless signal is a Bluetooth signal.

4. The mobile terminal of claim 1, wherein the wireless signal detector extracts an identifier of a shop corresponding to the wireless signal and transmits the extracted identifier of the shop to the application driver.

5. The mobile terminal of claim 4, wherein the application driver accesses a predetermined service server to acquire shop information corresponding to the identifier of the shop, and the shop information includes at least one of product information, price information, and event information.

6. A method of ordering and paying for a product by a mobile terminal, the method comprising:
detecting a wireless signal transmitted from the outside;
executing an application corresponding to the detected wireless signal;
receiving order information of a product selected by a user through the application and payment information related to the order information; and
transmitting the order information and the payment information and receiving a response to the transmitted order information and payment information.

7. The method of claim 6, further comprising receiving call information informing that a product corresponding to the order information and the payment information is prepared.

8. The method of claim 6, wherein the wireless signal is a Bluetooth signal.

9. The method of claim 6, wherein the detecting of the wireless signal comprises extracting an identifier of a shop corresponding to the wireless signal.

10. The method of claim 9, further comprising accessing a predetermined service server to acquire shop information corresponding to the identifier of the shop, wherein the shop information includes at least one of product information, price information, and event information.

11. A method of ordering a product using a mobile terminal, the method comprising:
transmitting a wireless signal corresponding to a particular shop by a wireless signal transmitter;
detecting the wireless signal transmitted from the wireless signal transmitter by a mobile terminal;
executing an application corresponding to the detected wireless signal by the mobile terminal;
transmitting order information of a product selected by a user through the application and payment information related to the order information to a service server by the mobile terminal;
transmitting the order information and payment information received from the mobile terminal to a shop terminal by the service server; and
receiving the order information and the payment information from the service server and displaying the received order information and payment information by the shop terminal.

12. The method of claim 11, further comprising:
transmitting call information informing that a product corresponding to the order information and the payment information is prepared to the service server by the shop terminal; and
transmitting the call information to the mobile terminal by the service server.

13. A non-transitory computer readable storage medium comprising commands for performing the method of claim 6.
